(19) United States
(12) Patent Application Publication
(10) Pub. No.: US 2026/0313201 A1
(43) Pub. Date: Oct. 8, 2026

(54) SYSTEM AND METHOD FOR PROVIDING AN APP STORE AND DEPLOYING APPLICATIONS ON A DUAL SCREEN TELEVISION

(71) Applicant: Telly, Inc., Sherman Oaks, CA (US)

(72) Inventors: Ilya Pozin, Los Angeles, CA (US); Shervin Pishevar, Miami, FL (US); Sascha Prueter, Daellikon (ZH); Eric Loes, Seattle, WA (US)

(73) Assignee: Telly, Inc., Sherman Oaks, CA (US)

(21) Appl. No.: 19/483,202

(22) PCT Filed: May 9, 2024
(86) PCT No.: PCT/US2024/028645

§ 371 Date: Nov. 10, 2025

Related U.S. Application Data
(60) Provisional application No. 63/465,190, filed on May 9, 2023.
(60) Provisional application No. 63/472,876, filed on Jun. 14, 2023.

(51) Int. Cl. H04N 21/462; G09G 3/20; H04N 21/431; H04N 21/436; H04N 21/4782

(52) U.S. Cl. CPC H04N 21/4622; G09G 3/20; H04N 21/4316; H04N 21/43615; H04N 21/4782; G09G 2320/0686; G09G 2354/00

(57) ABSTRACT

A method for providing an application store and deploying applications on a television system is provided. The television system may include a housing for a primary screen and a secondary screen, the secondary screen having a height less than the primary screen, a memory for storing instructions comprising an app store program, an input device, and/or a processor. The processor may display a first content on the primary screen. Concurrently, the processor may execute instructions for accessing, via the Internet, a database with available application programs available. The processor may also display, on the secondary screen, app store options. The processor may also receive, via the input device, app store commands. In response, the processor may download a new application from the database and store it in the memory. The new application downloaded from the database may include a widget that displays information on the secondary screen.

### RELATED APPLICATIONS

This application claims priority to U.S. Provisional Application Ser. No. 63/465,190, filed May 9, 2023, entitled “System and Method for Person Detection and Presence Control of Television with Integrated Camera or Radar,” and U.S. Provisional Application Ser. No. 63/472,876, filed Jun. 14, 2023, entitled “System and Method for Providing an App Store and Deploying Applications on a Dual Screen Television,” each of which is incorporated by reference herein in its entirety.

### TECHNICAL FIELD

The disclosed implementations relate generally to television displays and, more specifically, to a television that integrates two display portions in a vertical stack that includes an application store and application programs displayed in one screen, which may interactively control one or both screens and the speakers and optionally the camera or microphone, while content is concurrently displayed on the other screen.

### BACKGROUND

The proliferation of streaming video applications and the availability of video content online, has led to increased demands being placed on televisions to display traditional television content and make additional streaming or internet-based content available to television users. Limitations of existing televisions, however, lead to clumsy control and screen overlays designed to allow a user to interact with the television using a simple remote control to make viewing and content choices. These screen overlays only provide a limited amount of control, may interfere with viewing a currently displayed television program, particularly for others in the room, and do not lend themselves well to providing enhanced interactive features for the full range of possible interactive content and activities.

Existing televisions generally have incorporated a single display screen to present television content to users. Some televisions have allowed picture in picture for watching programs while navigating menus and split screen functionality that allows users to watch more than one television program at a time. However, this functionality has generally been limited to displaying programs and menus on the same screen at a reduced size. Televisions have also been arranged in arrays to allow single television sets to be physically placed in an array to each display part of a larger picture that is captured in the entire array.

### SUMMARY

Accordingly, there is a need for a television system that allows the presentation of a television program or streaming content in such a manner that the provision of additional content, features and functionality do not interfere with the television program. There is a further need for a television system that provides access to application programs and application program functionality that does not detract from a program or other content on the main screen. There is a further need for an integrated television that provides a rich set of applications for users to choose from that may be presented and launched in an unobtrusive manner and that may be used to control one or more integrated screens and speakers. There is a further need for a television that maximizes the ability to provide features, content and interactive functionality without the shortcomings of conventional televisions.

According to an embodiment, a television system includes a housing. The television system may include a primary screen in the housing. The primary screen may be configured to display first content. The television system may also include a secondary screen in the housing. The secondary screen may be configured to display second content. The secondary screen may have a height less than the primary screen. The television system may also include memory configured to store program instructions corresponding to application programs, including an app store program. The television system may also include a user input device configured to control the primary screen and the secondary screen. The television system may also include a processor configured to display the first content on the primary screen. The processor may be configured to, while displaying the first content, execute program instructions for the app store program, including: access, via the Internet, a database with application programs available for download; display, on the secondary screen, at least one store option; receive, via the user input device, one or more app store commands corresponding to one of the app store options; and/or in response to receiving the one or more app store commands, download, via the Internet, a new application corresponding to the one of the app store options, from the database, and store it in the memory.

In some embodiments, the new application program downloaded from the database, when executed by the processor, produces output corresponding to the new application on the primary screen. The output may be separate and distinct from the first content previously displayed on the primary screen.

In some embodiments, the new application, when executed by the processor, outputs data to a widget program, which in turn may configure data received from the new application and outputs it to the secondary screen.

In some embodiments, the new application downloaded from the database comprises a widget that displays information on the secondary screen while continuing to display the first content on the primary screen.

In some embodiments, the widget displays interactive content on the secondary screen while continuing to display the first content on the primary screen.

In some embodiments, the interactive content is related to the first content concurrently displayed on the primary screen.

In some embodiments, a selection of the interactive content causes the widget to launch, on the secondary screen, an application program found at a link accessible over the Internet, while continuing to display the first content on the primary screen.

In some embodiments, the processor is a special purpose media processor configured to generate audio visual content for display on the primary screen.

In some embodiments, the television system further includes a speaker. The audio visual content may be in a high-definition format synchronized with audio presented on the speaker.

In some embodiments, the secondary screen is integrated with the primary screen. The secondary screen may have a high-definition format, a size that is substantially the same width as the primary screen, and/or may have a height that is between ⅓ and ¼ the height of the primary screen.

In some embodiments, the memory may further include configuration information and/or user profile information for displaying application name, application image, and/or additional details, to allow launch of the application, using the input device.

According to some embodiments, a method is performed at a television system. The television system may include a housing, a primary screen and a secondary screen in the housing, the secondary screen having a height less than the primary screen, a memory for storing program instructions comprising an app store program, a user input device, and/or a processor. The method may include display a first content on the primary screen. The method may also include, while displaying the first content, executing program instructions for the app store program, including accessing, via the Internet, a database with application programs available for download. The method may also include displaying, on the secondary screen, at least one app store options. The method may also include receiving, via the user input device, one or more app store commands corresponding to one of the app store options. The method may also include, in response to receiving the one or more app store commands, downloading, via the Internet, a new application corresponding to the one of the app store options, from the database, and store it in the memory.

In some embodiments, the new application program downloaded from the database, when executed by the processor, produces output corresponding to the new application on the primary screen. The output may be separate and distinct from the first content previously displayed on the primary screen.

In some embodiments, the new application, when executed by the processor, outputs data to a widget program, which in turn may configure data received from the new application and outputs it to the secondary screen.

In some embodiments, the new application downloaded from the database includes a widget that displays information on the secondary screen while continuing to display the first content on the primary screen.

In some embodiments, the widget displays interactive content on the secondary screen while continuing to display the first content on the primary screen.

In some embodiments, the interactive content is related to the first content concurrently displayed on the primary screen.

In some embodiments, a selection of the interactive content causes the widget to launch, on the second screen, an application program found at a link accessible over the Internet while continuing to display the first content on the primary screen.

In some embodiments, the processor is a special purpose media processor. The method may further include generating, using the processor, audio visual content for display on the primary screen.

In some embodiments, the television system further includes a speaker. The method may further include generating the audio visual content in a high-definition format synchronized with audio presented on the speaker.

In some embodiments, the secondary screen is integrated with the primary screen. The secondary screen may have a high-definition format, a size that is substantially the same width as the primary screen, and/or may have a height that is between ⅓ and ¼ the height of the primary screen.

In some embodiments, the memory further includes configuration information and/or user profile information. Executing the program instructions for the app store program may further include displaying application name, application image, and/or additional details, to allow launch of the application, using the input device.

According to an embodiment, a television has two screens that are integrally contained in a housing. One of the screens is a main screen and the other is smaller and may be used to provide ancillary, interactive functionality including the provision of application programs that may control one or both screens and/or speakers. The second screen may be configured to display an app store and multiple application programs, in addition to additional information, such as the time, weather information, and news, or user configured widgets among other things. The application programs themselves may be launched and interactively controlled via a microphone, a remote control, or a virtual remote control on a mobile phone and may output content to the main screen and/or the ancillary screen and via the speakers.

According to an embodiment, the app store and/or application launching system may help retrieve applications. An integrated television may provide two integrated television screens. The lower television screen may be approximately ¼ to ⅓ the height of the upper screen, which may be 16:9. This allows a television viewer to watch a standard 16:9 VT screen while simultaneously watching a smaller, lower screen for multitasking. Additionally, the lower screen can be on while leaving the upper screen for media consumption including text, graphics, advertising, video, and audio. This arrangement facilitates providing a full range of interactive content, control and features to users via the provision of applications that may control either screen or both screens simultaneously. Such applications enable the linking of content, control and features between the two screens and ancillary devices, such as a sound bar, camera, or microphone, which may also be integrated into the television.

According to another embodiment, a television system with separate, integrated screen hardware portions in the same housing, comprises: a first screen capable of presenting content in a high definition format; a second screen integrally provided with the first screen, the second screen having the high definition format and a size that is substantially the same width as the first screen and between ⅓ and ¼ the height; a memory for storing program instructions corresponding to application programs, including an app store program, configuration information and user profile information; a remote control capable of controlling both screens; and a media processor, coupled with the screens, memory, remote control and the Internet, capable of (i) executing program instructions for the app store program causing the processor to access a database via the Internet with application programs available for download to the television, (ii) present on the second screen to the user app store options, (iii) registering app store commands and selections from the user using a television remote control, (iv) downloading a new application from the app store and storing it in the memory of the television, and (v) concurrently with user interaction with the app store program on the second screen, displaying separate content on the first screen.

Application programs downloaded from the app store, when executed by the processor, may produce output on the main screen or secondary screen. Such applications may also output data to a widget program that produces output on the second screen. The application downloaded may also be a widget that presents information on the second screen, including interactive content, interactive content linked to content on the main screen, and interactive content that is linked to an application accessible over the Internet. The application downloaded also might be orthogonal to the main screen, performing a separate function and/or use case for the user, example being ability to play a video game on lower screen while watching content on main screen.

According to another embodiment, a method of operating a television with separate, integrated screen hardware portions in the same housing, includes: continuously presenting, under control of a media processor, audio visual content on a first screen in a high-definition format synchronized with audio presented on a speaker associated with the television; presenting on a second screen integrally provided with the first screen an application store display using the media processor, the second screen having the high-definition format and a size that is substantially the same width as the first screen and between ⅓ and ¼ the height; storing program instructions corresponding to application programs, including the app store program, configuration information and user profile information; receiving remote control signals capable of controlling the television and both screens; executing the app store program to retrieve available app store programs via the Internet; presenting on the second screen to the user app store options; registering app store commands and selections from the user using the remote control, microphone, or virtual remote; and downloading a new application from the app store and storing it in a memory of the television, coupled with the processor.

According to some embodiments, the integrated television screens may comprise separate television panels integrated into a single television, with or without a soundbar. In other embodiments, for example, a single 4:3 panel may be configured with a physical screen divider and software for dividing the video into two separate integrated screens. According to one embodiment, the HDMI port may deliver video to the upper 16:9 section only. In other embodiments, the HDMI port may deliver video to the upper and lower sections.

According to another embodiment, the lower display of an integrated television displays information that is concurrent and related to information displayed on the upper screen of the same television. This facilitates providing relevant application programs, advertising and interactive content to users in a way that is additive and that does not detract from the content on the upper screen.

In another aspect, a computer system includes one or more processors, memory, and one or more programs stored in the memory. The programs are configured for execution by the one or more processors. The programs include instructions for performing any of the methods described herein.

In another aspect, a non-transitory computer readable storage medium stores one or more programs configured for execution by one or more processors of a computer system. The programs include instructions for performing any of the methods described herein.

### BRIEF DESCRIPTION OF THE DRAWINGS

The above described features and advantages of the present invention will be more fully appreciated with reference to the following figures.

FIG. 1 shows a television system, according to an embodiment.

FIG. 2 is a block diagram of a television system, according to an embodiment.

FIG. 3 is a schematic diagram of an example system for acquiring and presenting applications to users of a television system, according to an embodiment.

FIG. 4 is a schematic diagram of a process for operating application programs on a television system, according to an embodiment.

FIG. 5 is a block diagram of an application program store associated with a television system, according to an embodiment.

FIG. 6 is a flow diagram of an example method of operating application programs on a television system, according to an embodiment.

FIG. 7 is a schematic diagram of an example system for operating application programs on a television system to generate and deploy a widget, according to some embodiments.

FIG. 8 is a flow diagram of an example method for providing an application store and/or deploying applications on a television system, according to some embodiments.

Like reference numerals refer to corresponding parts throughout the drawings.

### DESCRIPTION OF IMPLEMENTATIONS

Reference will now be made to various implementations, examples of which are illustrated in the accompanying drawings. In the following detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

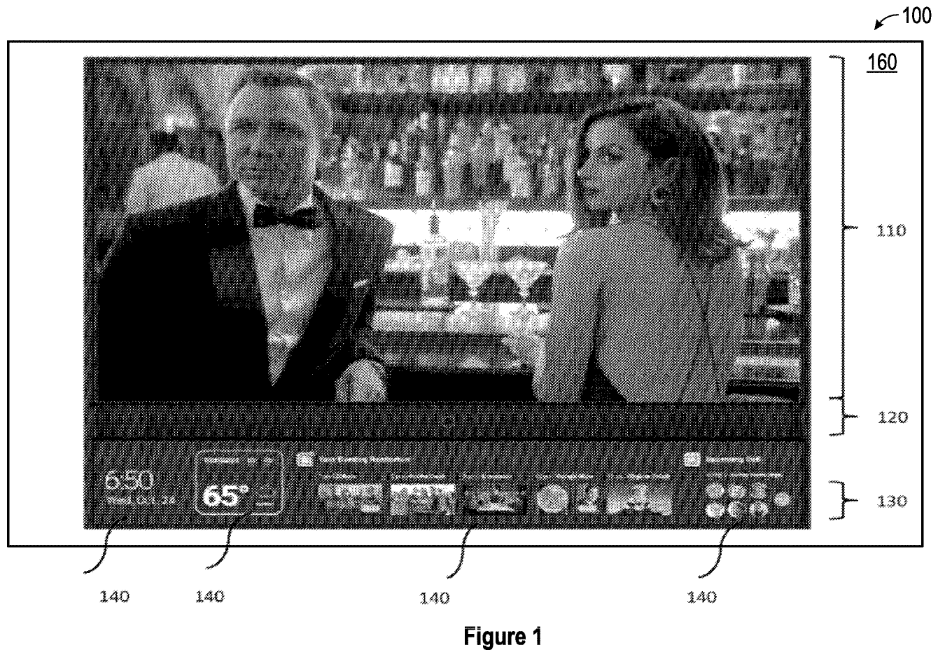

Disclosed embodiments enable provision, deployment and/or control of an app store on a television system with a plurality of screens. Systems, methods, devices and/or interfaces implementing the techniques in accordance with some embodiments are illustrated in FIGS. 1-7.

According to an embodiment of the present invention, a television has two screens that are integrally contained in the housing. One of the screens is the primary screen (sometimes referred to as the main screen). The other screen (sometimes referred to as the secondary screen or the second screen) may be smaller and/or may be used to provide ancillary, interactive functionality including the provision of application programs that may control one or both screens and speakers. The second screen may be configured to display an app store and multiple application programs, in addition to widgets that present information statically, dynamically, and/or interactively, such as the time, weather information, and news, among other things. The application programs and widgets themselves may be launched and/or interactively controlled via one or more input devices (e.g., a microphone, a remote control, a virtual remote), and/or may output content to the main screen, the secondary screen, speakers, and/or any audiovisual output devices.

### Example Configurations for User Launch And/or System Lunch of Applications

Application configuration metadata may be used to display application name, application image, and/or additional details, to allow launch of the application using a remote control and/or voice control. An application or widget may be launched by a user and/or by the system (e.g., automatically, without user input). A user launch of a widget and or application can be done using an input device (e.g., a remote control) and/or by navigating to the intended experience and/or selecting (e.g., by clicking with the remote control and/or by executing a known voice command) to launch and/or view an application and/or widget. A system launch may be predicated on various events happening on device and/or on backend services. A rules engine may be configured to determine if and/or when a widget is to be shown. These events may include but are not limited to the time of day, content being watched, promotional dates, etc. When criteria has been met, the system may use the application configuration metadata to launch the experience for user consumption.

FIG. 1 shows a television system 100 that integrates two screens and concurrent functionality, according to an embodiment. In this example, the television system integrates two distinct screens and concurrent functionality. The television system may include a housing (e.g., the housing 160), an upper screen 110 (sometimes referred to as a main screen, a first screen, a primary screen), and a lower screen 130 (sometimes referred to as a secondary screen, a second screen). The main screen and secondary screen may be separated by an optional sound bar 120. Alternatively, the screens may be separated by a physical divider or placed adjacent to one another. The lower screen may be apportioned into areas where the screen output is determined by widget programs 140. The widget programs 140 may present information, interactive or otherwise.

According to an embodiment, the lower television screen is approximately ¼ to ⅓ the height of the upper screen which may have an aspect ratio of 16:9. This allows a television viewer to watch a standard 16:9 VT screen while simultaneously watching a smaller, lower screen for multitasking. Additionally, the lower screen can be on while leaving the upper screen for media consumption including text, graphics, advertising, video, and audio. This arrangement facilitates providing a full range of interactive content, control and features to users via the provision of applications that may control either screen or both screens simultaneously. Such applications enable the linking of content, control and features between the two screens and ancillary devices, such a sound bar, which may also be integrated into the television.

According to some embodiments, the integrated television screens may comprise separate television panels integrated into a single television, with or without a soundbar. In other embodiments, for example, a single 4:3 panel may be configured with a physical screen divider and hardware and software provisioning to divide the television into two separate integrated screens. According to one embodiment, HDMI ports may deliver video to the upper screen only. In other embodiments, the HDMI ports may deliver video to the upper and lower sections.

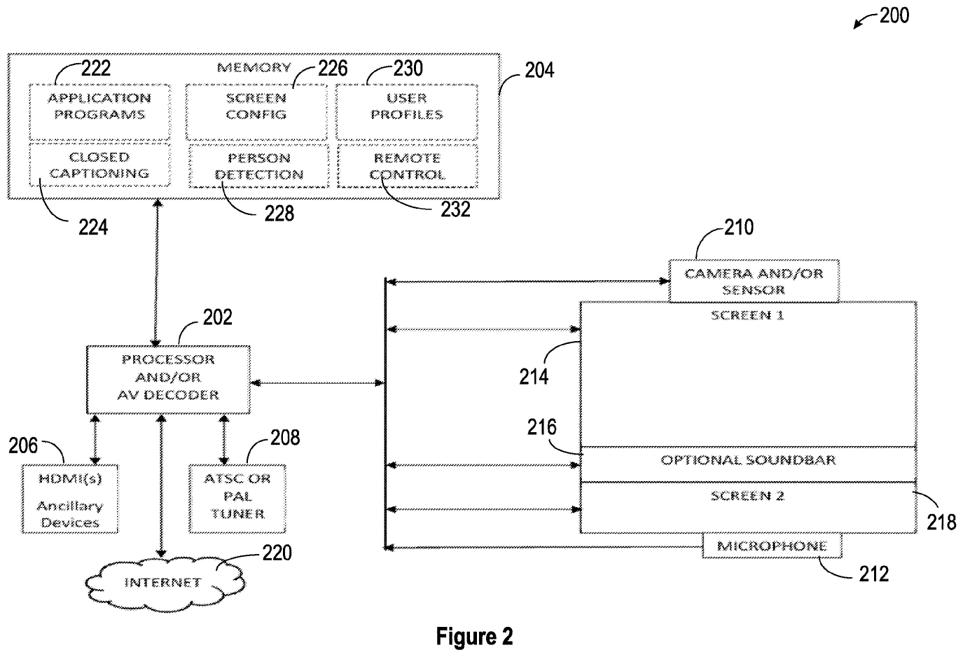

FIG. 2 is a block diagram of a television system 200 (e.g., the television system 100) that integrates two distinct screens and concurrent functionality, according to an embodiment. The television system may include a processor 202 coupled with a memory 204, HDMI ports 206, an ATSC or PAL tuner 208, a camera and/or sensor 210, a microphone 212, speakers or an optional soundbar 216, the Internet 220, and/or screens (e.g., screen 1, labeled 214; screen 2, labeled 218) as described above. The memory 204 may store programs that include program instructions that are executed by the processor to enable the various functionalities of the television system. The memory 204 may include, for example, application programs 222, a closed captioning program 224, a screen configuration program 226, a person detection program 228, a user profile program 230, and/or a remote control program 232 (sometimes referred to as user input program, e.g., programs to process user input). The memory 204 may include programs in addition to, or instead of, the programs shown in FIG. 2, related to processing one or more operations described herein.

The HDMI ports 206 may enable A/V devices to be connected to the television, including DVD players, DVRs, sound bars, streaming boxes, A/V Receivers, gaming consoles and/or other equipment. The ATSC or PAL tuners 208 may be incorporated into the television system 200 to allow the television system to, for example, receive over the air and/or certain cable broadcasts and/or display (or present) them on the main screen (e.g., the screen 214) and/or on the secondary screen (e.g., the screen 218).

The microphone 212 may allow the user to provide spoken commands to the television, to allow for video conferencing, and/or to allow other audio visual applications. The camera 210 may also be provided to facilitate functionality such as to permit video conferencing and for gesture and motion recognition and the sensor 210 may also be provided to facilitate functionality, such as determining the number of viewers of the television system 100, among other features. The screens may be distinct and/or render images corresponding to content from the HDMI ports, from the tuners, from the Internet, streaming and/or other interconnected devices. In addition, the content of the screens may be determined by application programs or any of the other programs stored in the memory 204 and/or executed by the processor. The speakers and/or optional soundbar 216 may be used to provide audio output corresponding to content displayed on the screens and/or enabled through the application programs and/or other programs provided on the television system. The television system 200 may also incorporate a RF receiver or RI port for receiving signals from a remote control (or any input device) used to control the television.

The processor 202 may be a single microprocessor, multiple processors, or a processor and a co-processor. In one embodiment, a primary microprocessor may be used to render and/or operate the user interface while a second processor may be used to decode video, for example H.264 format outputting a signal via HDMI. The processors 202 may support all functionality needed to operate the display screens of the television, and/or synchronize images with audio output, including rendering, video decoding, audio decoding, audio visual synchronization control, motion estimation and/or motion compensation, picture quality, time stamp normalization, frame rate control, and/or over the air updates. In addition, the processors 202 may execute program instructions from the memory 204 to enable applications to be presented on one or both screens of the television, and/or to permit use of the speakers, microphone, cameras, internet connection, remote control, and/or two-way communication with ancillary devices connected to the television, such as content streaming hardware. According to an embodiment of the present invention, the processor may be an application processor designed specifically for smart display applications, and may include, for example, CPU/GPU subsystems, video codecs, graphics subsystems, video engines, video/graphics output pipelines, HDMI receiver ports, demultiplexers for broadcast and streaming video, digital signal processors (DSPs) for processing audio, peripheral interfaces such as for Ethernet, USB, SDIO 3.0, eMMC 5.1, SDIO/SD card controller, UART, I2C, high-speed SPI PWMs and an RI blaster. The processor 202 may be distributed or a system on a chip and may interface with additional memory and components of the television.

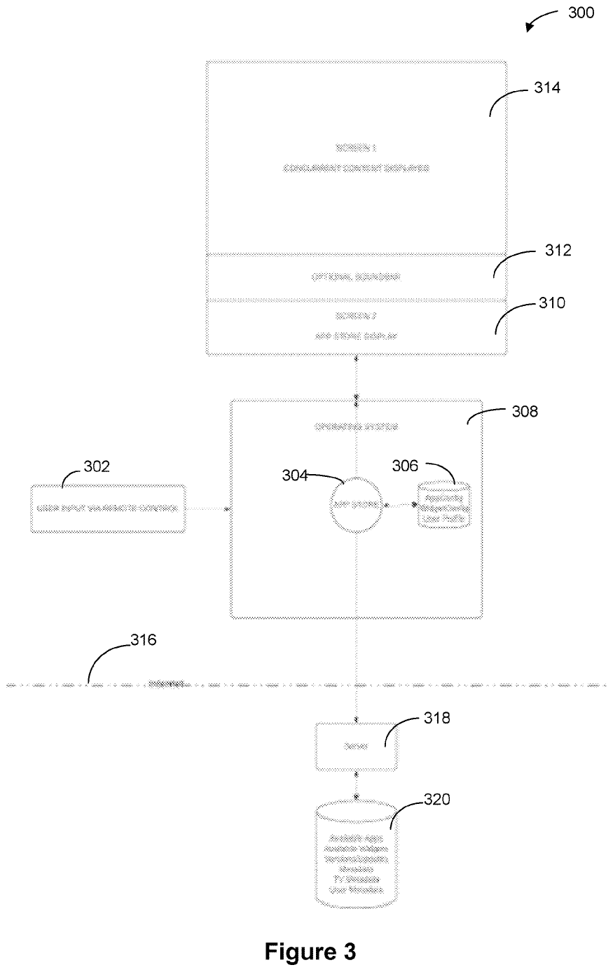

FIG. 3 is a schematic diagram of an example system 300 for acquiring and presenting applications to users of a television system that integrates two distinct screens according to an embodiment. The system may be implemented using the television system 100 or the television system 200 described above. The system 300 may include an input device 302 (e.g., a remote control, a voice input device, a virtual remote), which is used to control an application store 304 (sometimes referred to as an app store), an application resident in a memory (e.g., the memory 204), which may be displayed on a secondary screen 310. The app store 304 may be coupled via the Internet 316 to a database 320 of available applications, widgets and versions of the same (e.g., via a server 318). The app store 304 may also include an identification of each television system with which the app store interacts to facilitate communication and updates. The app store 304 may be an application in an operating system 308 of the television system 300. The app store 304 may interact with local information 306 stored in memory on the television system, such as application configuration settings, widget configuration settings and user profile information, including a user identification, password, and/or preferences. If the user selects the app store 304 program, the app store program may present, for example, on a secondary screen 310, a search window to find application programs, and/or present a scrollable list (e.g., to a user). The user may have a program concurrently running on a main screen 314 and/or speakers 312 (or sound bar), while using the app store app. Once an application is selected from the app store 304, the program may be transmitted from the app store to the television system and stored in memory of the television system by a processor. The application store may also allow the ability to auto download applications and showcase them in the system navigation on the secondary screen 310 and allow user(s) to browse and launch applications without the need to discover and install applications.

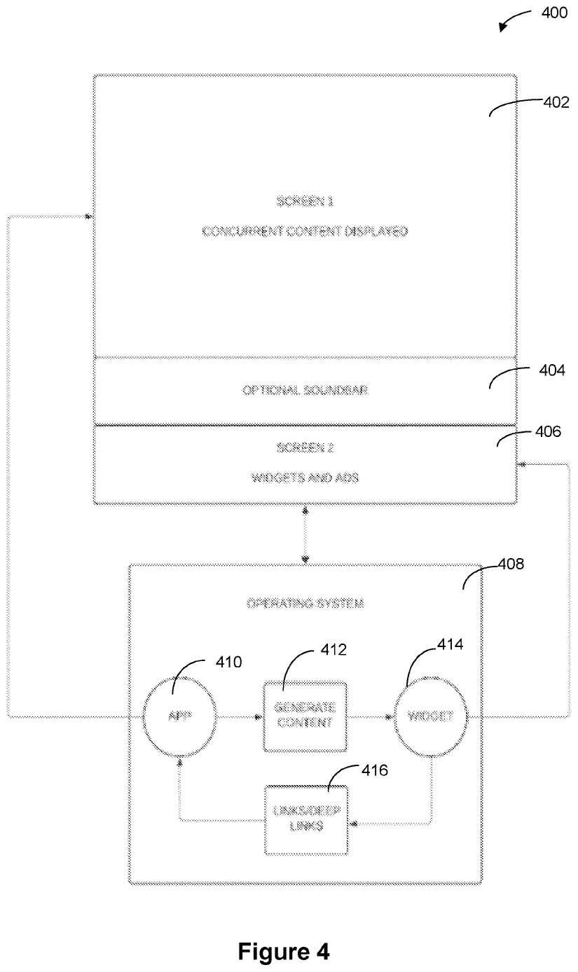

FIG. 4 is a schematic diagram of an example process 400 for operating application programs on a television system (e.g., the television system 100, the television system 200) according to an embodiment. Widgets 414 and application programs 410 may be apportioned over two distinct screens (e.g., a first screen 402 and a second screen 406, screens of an integrated two screen television system), according to an embodiment. Application programs may be configured to display video, audio, graphic, or text output to a main screen 402. Widgets may be configured to display video, audio, graphic, or text output to a secondary screen 406. Widget output may include widget cards and widget pages, which each present information to the user on, for example, weather, sports or news. Widget cards may have a predetermined width and may present information to the user that takes up a portion of the width of the screen. Widget pages may take up to the entire width of the secondary screen. Each widget card or page may present information, to the user such as sports scores, news items etc. The user may select widget cards to populate the second screen, and may configure each widget to present personalized information to the user. For example, sports widgets may be configured to allow selection of individual teams, leagues or sports to allow the customized presentation of current information to the user. Widgets may run and be continuously updated, even while content is presented on the main screen. The user may interact with application programs to configure widgets and the application programs may be executed by the television system to generate content 412 for the widgets that are running on the television system in the secondary screen 406 at any given time. The widgets 414 may include links or deep links 416, such that when a user using the television remote control selects an interactive, selectable feature of a widget, which causes an application program found at the link to launch and present content on the main screen or secondary screen. Deep links may be to content applications, such as streaming applications, to advertisements, or to information about sports teams, news or other information sources.

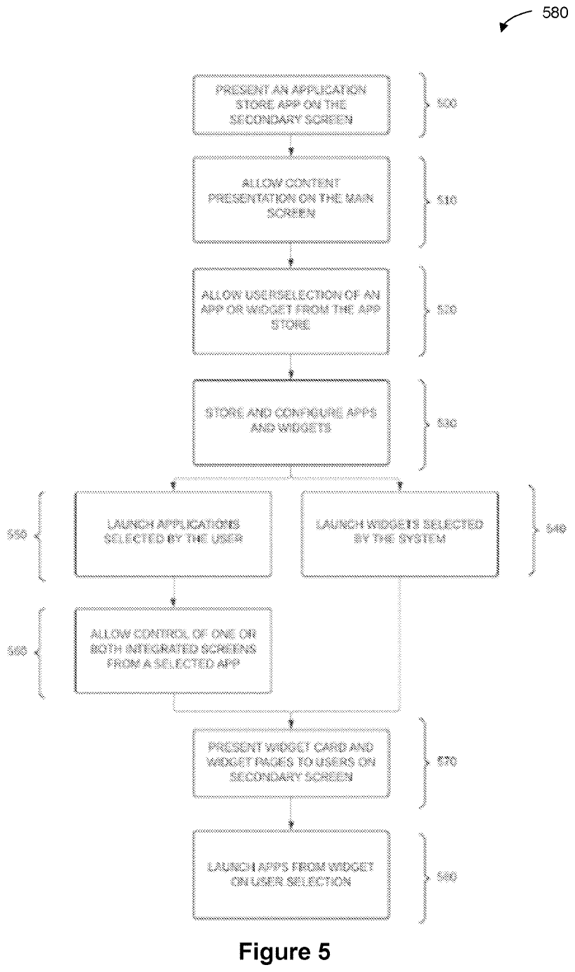

FIG. 5 is a flow diagram of an example application program 580 (sometimes referred to as an app store program, an application), according to an embodiment. A processor (e.g., the processor 202) of a television system (e.g., the television system 200) may execute program instructions stored in a memory (e.g., the memory 204) for an app store application and may present (500) the app store application on a secondary screen to a user.

In 510, the processor may allow the simultaneous presentation of content on a main screen, in such a manner that the app store program does not interfere with the presentation of the content on the main screen.

In 520, the processor allows the user to select, using a remote control, an application program and/or widget from an app store.

In 530, the processor stores the app selected in the memory of the television system. The user may then configure the application and/or widget and launch them using the remote control. In general, the widget may be arranged in cards on the secondary screen and certain apps may be selected to run. In addition, other apps or widgets after download from the app store may become available to the user to select and run, but may not be running at any given time when not selected.

In 540, an app and/or widget may be selected that provides output to one or both screens. This step may be controlled by the television remote control or verbal commands. The system may control when to display widgets.

In 550, widget cards or pages may be presented to the user on the secondary screen according to the selected user configuration or user profile.

In 560, apps may be launched interactively by the user selecting an interactive feature output by a widget, which causes an application to run that is found at the link. The application may cause content, interactive or otherwise, to be displayed on the main screen of the television.

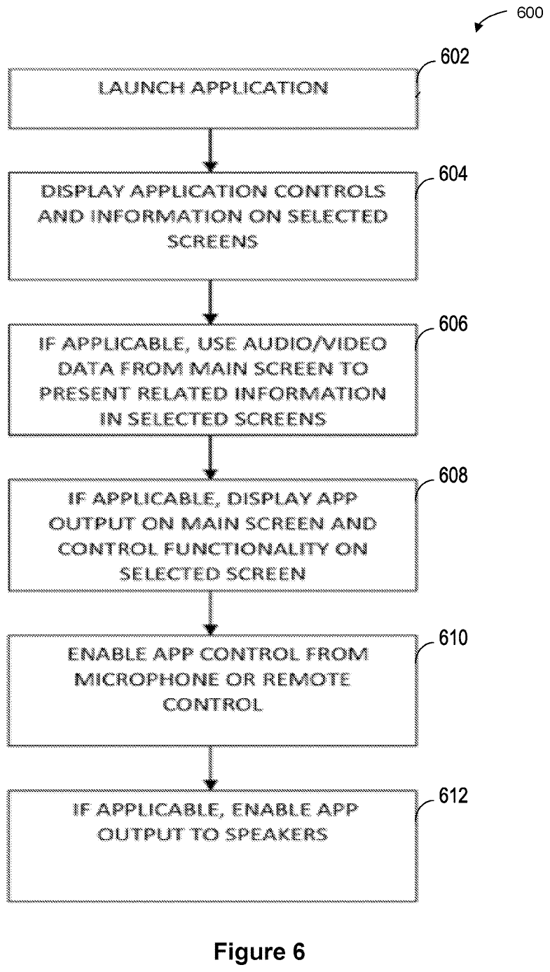

FIG. 6 is a flow diagram of an example method 660 of operating application programs on a television system (e.g., the television system 200), according to an embodiment.

In 602, an application program is launched on the television system, causing a processor to execute the program instructions corresponding to the selected application.

In 604, application controls and related information may be presented to the user on the main or the secondary screen selected or configured by the application. Application controls may include application data presented to a user on the secondary screen in a navigable and/or selectable format and/or selection of data. The data may include graphic, video, audio, and/or text representation.

In 606, the user may select interactive content on the main screen, which causes the presentation of information related to the selection on the secondary screen. As an example, in an interactive television program, this may include allowing the user to select an item on screen, such as a piece of furniture, and display information about the furniture, such as where to buy it and its cost.

In 608, the app may provide control functionality in the second screen that is related to content being presented on the main screen. For example, the control functionality may include interactive functionality including the ability for the application to control one or both screens and/or speakers. While the application is running, the second screen may be configured to display an app store and/or multiple application programs, in addition to widgets that present information statically, dynamically, and/or interactively, such as the time, weather information, and news, among other things.

In 610, the user may select, using the remote control or microphone, functionality made available on the second screen during the normal presentation of the program on the main screen. For example, the application programs and widgets themselves may be launched and/or interactively controlled via one or more input devices (e.g., a microphone, a remote control, a virtual remote), and/or may output content to the main screen, the secondary screen, speakers, and/or any audiovisual output devices.

In 612, the application program may enable output to the speakers by the main application program, or by sending audio content associated with the information on the secondary screen to the speakers or optional sound bar. The app store may further include a configuration portion that facilitates collecting user id, password and payment information from users that is used to authorize and charge users for application purchases.

In this manner, a television system may incorporate two interactive screens and provide a robust, interactive experience to users that includes the ability to download and supplement the television with additional application programs using the second screen. While particular embodiments have been shown and described herein, it will be understood by those having ordinary skill in the art that changes may be made to those embodiments without departing from the spirit and scope of the invention.

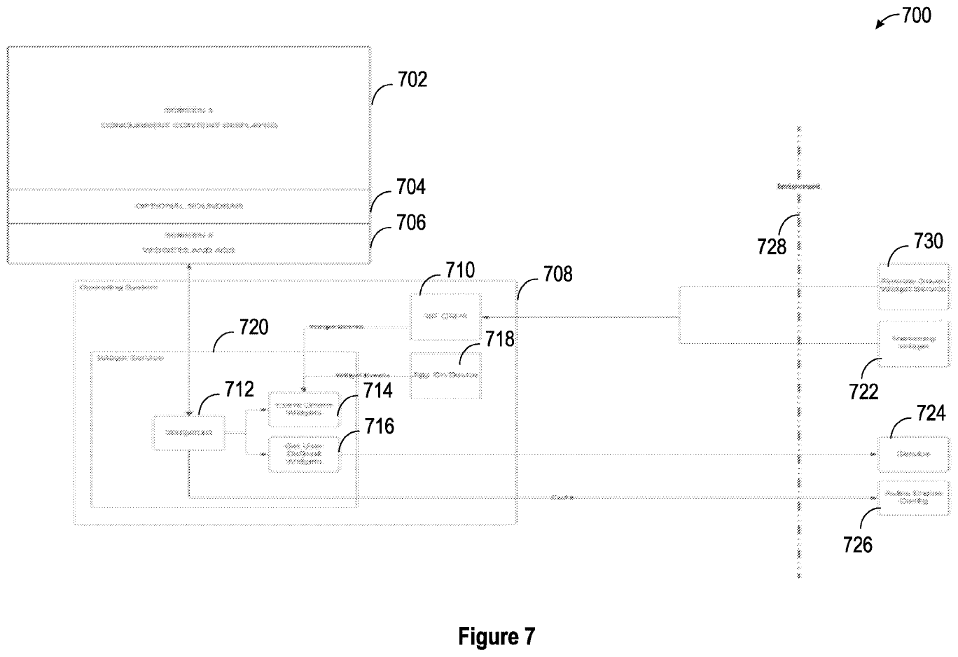

FIG. 7 is a schematic diagram of an example system 700 for operating application programs on a television system (e.g., the television system 200; sometimes referred to as the system) to generate and deploy a widget, according to some embodiments. The television system may include a first screen 702, an optional soundbar 704, and/or a second screen 706. The second screen may be configured to display widgets and/or ads, and the first screen may be configured to display concurrent content. The system 700 may include an operating system 708, which may in turn include an Internet-of-Things (IoT) client 710. The operating system 708 may include a publish-subscribe application that provides the ability to remotely send data to and from the device over communication protocols (e.g., Websocket, MQTT). The operating system 708 may include an application on device 718 (sometimes referred to as application programs), and/or a widget service 720. The widget service 720 may be a collection of instructions and/or rules to determine what widgets should be actively shown on the secondary screen. The widget service 720 may include a widget list 712, an event driven widgets 714, and/or user-defined widgets 716. The application programs 718 may be allowed (e.g., by the operating system 708) to run in the background on the system and notify the system (e.g., the event driven widgets 714) when to present a widget. The notification may be event based (e.g., content being played on TV, people detected, profile detected, a certain time of day, a marketing event, or some other reason). The system may then determine if the widget should be displayed. For example, the event driven widgets 714 may obtain a widget from the widget list 712 and/or display (or cause to display) the widget based on the notification. The widgets (e.g., the widget service 720) may be configured to display video, audio, graphic, or text output to the secondary screen 706. The determination of when to show a widget may help ensure that the overall user experience is not flooded by any one particular application widget. Users and/or the system may review the ecosystem of application widgets and elect to interact with a particular application widget. Examples for determination to show a widget may include but not limited to the following: frequency cap by limiting how often the application widget is launched, duration caps-limit how often an application widget is seen per day, and user preference for widgets from a particular application. In some embodiments, an application may transmit, to the television system, a predetermined number of requests (e.g., ten requests per day) to display secondary content. The television system may be configured to allow a predetermined number (e.g., three per day) of display of a content, so the television system may refrain from displaying the secondary content. The widget list 712 may obtain user-defined widgets 716 using a service 724 over the Internet 728. The IoT client 710 may handle IoT sensor output from one or more IoT devices coupled to the system, may obtain widgets from a remote-driven widget service 730 (e.g., a widget service coupled via an input device, such as a remote control) and/or marketing widgets service 722, via the Internet 728. The widget list 712 may cache one or more widgets (e.g., without having to fetch widgets from the event-driven widgets 714 and/or the user-defined widgets 716). The caching may be based on rules from a rules engine configuration service 726, which may be accessible via the Internet 728.

In some embodiments, the remote widget service 730 pushes dynamic data to the IoT client 718. For example, the remote widget service 730 may push content matching data to the IoT client 718 to enable interactive widgets based on content being played. A new widget may be added to the user defined widgets 716. A notification may be generated to refresh the widget list 712 and/or to show the new widget. A widget may be removed from the widget list and/or a notification may be generated to refresh the widget list. In some embodiments, the marketing widget service 722 provides the ability to show promotional information. For example, such information may include non-systematic widgets that allow ability for any generic messaging through a widget to the end user. For example, such information may include reminders for users (e.g., a reminder that the Super Bowl is on a specific Sunday), notifications regarding software updates that are ready to be installed, and any system notifications (e.g., “check out the new games installed on your TV”). In some embodiments, the service 724 may include the weather service, which may allow a weather widget to be shown with local weather information for the device location. The rules engine configuration service 726 may include an remote service that allows ability to dynamically change the rules for the device widget service 720 (e.g., change rules for frequency and/or types of widgets to be shown and/or when). For example, it may be possible to change a weather widget to be always shown always and/or to limit weather widget to only be shown when significant weather events occur.

Widget output may include widget cards and widget pages, each of which may present information to the user on, for example, weather, sports or news. Widget cards may have a predetermined width and that present information to the user that takes up a portion of the width of the screen. Widget pages may take up to the entire width of the second screen. Each widget card or page presents information to the user, such as sports scores, news items etc. Widgets may run and be continuously updated, even while content is presented on the main screen. The user may interact with an application programs widgets and the application programs may be executed by the television to generate content for the widgets that are running on the television in the secondary screen at any given time. The widgets may include links or deep links, such that when a user using the television remote control selects an interactive, selectable feature of a widget, which may cause an application program that is currently not running on the main screen to be found at the link to launch and present content on the main screen and/or secondary screen. Deep links may be to content applications, such as streaming applications, to advertisements, or to information about sports teams, news or other information sources.

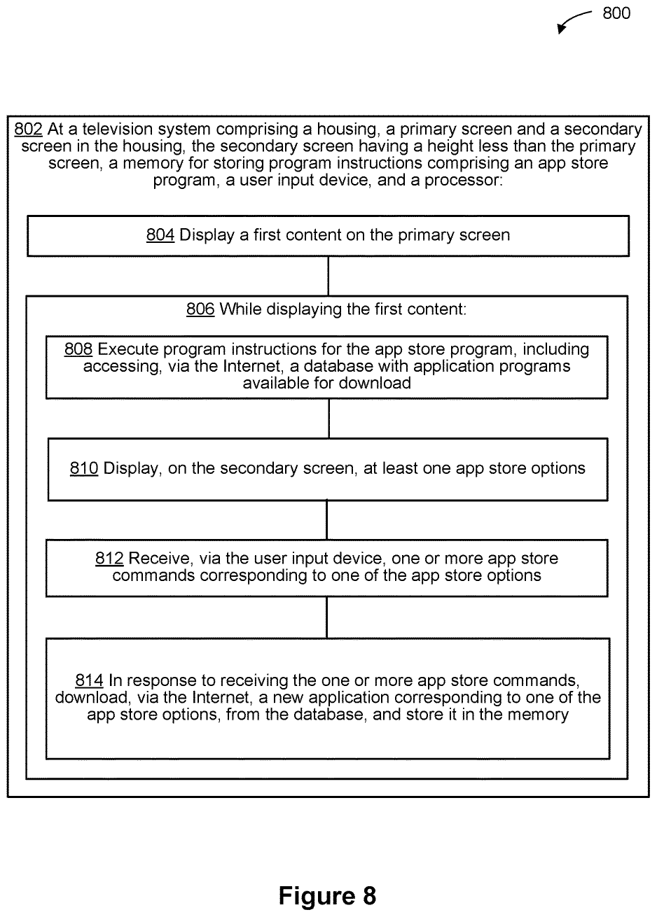

FIG. 8 is a flow diagram of an example method 800 for providing an application store and/or deploying applications on a television system, according to some embodiments. The method may be performed (802) at a television system (e.g., the television system 200). The television system may include a housing (e.g., the housing 160 that encompasses or houses screens and/or sound bar of the television system 100), a primary screen (e.g., the screen 214) and a secondary screen (e.g., the screen 218) in the housing, the secondary screen having a height less than the primary screen, a memory for storing program instructions comprising an app store program (e.g., the app store 304), a user input device (e.g., the user input device 302), and/or a processor (e.g., the processor 202).

The method may include displaying (804) a first content on the primary screen. The method may also include, while displaying the first content (806), executing (808) program instructions for the app store program, including accessing, via the Internet, a database with application programs available for download. The method may also include displaying (810), on the secondary screen, at least one app store options (e.g., ability to browse, install, uninstall applications to the television system). The method may also include receiving (812), via the user input device, one or more app store commands (e.g., navigation, select, keyboard, back, exit) corresponding to one of the app store options. The method may also include, in response to receiving the one or more app store commands, downloading (814), via the Internet, a new application corresponding to the one of the app store options from the database and storing it in the memory.

In some embodiments, the new application program downloaded from the database, when executed by the processor, produces output on the primary screen corresponding to the new application on the primary screen. The output may be separate and distinct from the first content previously displayed on the primary screen.

In some embodiments, the new application, when executed by the processor, outputs data to a widget program, which in turn may configure data received from the new application and outputs it to the secondary screen while continuing to display the first content on the primary screen. Examples of widget processing are described above in reference to FIG. 7, according to some embodiments. An application may run on either screen or both screens as a full window application. An application may also have the ability to show a widget within the operating system when it is running or not actively running. For example, suppose an application is running on the main screen. The application may also have a companion widget running at the same time. As another example, suppose an application is not actively running on either screen, but does have a widget running on the operating system. A user can select said widget which may in turn open the application on either or both screens.

In some embodiments, the new application downloaded from the database includes a widget (sometimes referred to as a widget program) that displays information on the secondary screen while continuing to display the first content on the primary screen. In some embodiments, the method further includes determining when to show the widget based on one or more of: limiting how often an application widget is launched, limiting how often an application widget is seen per day, and user preference for widgets from a particular application. The relationship between applications and widgets may be one-to-many. For example, more than one widget may be associated with an application. In some embodiments, the widget displays interactive content on the secondary screen. In some embodiments, the interactive content is related to the first content concurrently displayed on the primary screen. In some embodiments, a selection of the interactive content causes the widget to launch, on the secondary screen, an application program found at a link accessible over the Internet while continuing to display the first content on the primary screen.

In some embodiments, the processor is a special purpose media processor. The method may further include generating, using the processor, audio visual content for display on the primary screen.

In some embodiments, the television system further includes a speaker (e.g., the optional soundbar 216). The method may further include generating the audio visual content in a high-definition format synchronized with audio presented on the speaker.

In some embodiments, the secondary screen is integrated with the primary screen, an example of which is described above in reference to FIG. 1. The secondary screen may have a high-definition format, a size that is substantially the same width as the primary screen, and/or may have a height that is between ⅓ and ¼ the height of the primary screen.

In some embodiments, the memory further includes configuration information and/or user profile information. Executing the program instructions for the app store program may further include displaying application name, application image, and/or additional details, to allow launch of the application, using the input device.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A television system comprising:
a housing;
a primary screen in the housing, the primary screen configured to display a first content;
a secondary screen in the housing, the secondary screen configured to display a second content, the secondary screen having a height less than the primary screen;
a memory configured to store program instructions corresponding to application programs, including an app store program;
an input device configured to control the primary screen and the secondary screen; and
a processor configured to:
display the first content on the primary screen; and
while displaying the first content:
execute program instructions for the app store program, including accessing, via the Internet, a database with application programs available for download;
display, on the secondary screen, at least one app store options;
receive, via the input device, one or more app store commands corresponding to one of the app store options; and
in response to receiving the one or more app store commands, download, via the Internet, a new application corresponding to the one of the app store options from the database and store it in the memory.

2. The television system of claim 1, wherein the new application downloaded from the database, when executed by the processor, produces output corresponding to the new application, on the primary screen, wherein the output is separate and distinct from the first content previously displayed on the primary screen.

3. The television system of claim 2, wherein the new application, when executed by the processor, outputs data to a widget program, which in turn configures data received from the new application and outputs it to the secondary screen.

4. The television system of claim 2, wherein the new application downloaded from the database comprises a widget that displays information on the secondary screen while continuing to display the first content on the primary screen.

5. The television system of claim 4, wherein the processor is further configured to:
determine when to show the widget based on one or more of: limiting how often an application widget is launched, limiting how often an application widget is seen per day, and user preference for widgets from a particular application.

6. The television system of claim 4, wherein the widget displays interactive content on the secondary screen while continuing to display the first content on the primary screen.

7. The television system of claim 6, wherein the interactive content is related to the first content concurrently displayed on the primary screen.

8. The television system of claim 7, wherein a selection of the interactive content causes the widget to launch, on the secondary screen, an application program found at a link accessible over the Internet while continuing to display the first content on the primary screen.

9. The television system of claim 1, wherein the processor is a special purpose media processor configured to generate audio visual content for display on the primary screen.

10. The television system of claim 9, further comprising a speaker, wherein the audio visual content is in a high-definition format synchronized with audio presented on the speaker.

11. The television system of claim 1, wherein the secondary screen is integrated with the primary screen, wherein the secondary screen has a high-definition format, a size that is substantially a same width as the primary screen, and has a height that is between ⅓ and ¼ the height of the primary screen.

12. The television system of claim 1, wherein the memory further comprises configuration information and/or user profile information for displaying application name, application image, and/or additional details, to allow launch of the new application, using the input device.

13. A method comprising:
at a television system comprising a housing, a primary screen and a secondary screen in the housing, the secondary screen having a height less than the primary screen, a memory for storing program instructions comprising an app store program, an input device, and a processor:
displaying a first content on the primary screen; and
while displaying the first content:
executing program instructions for the app store program, including accessing, via the Internet, a database with application programs available for download;
displaying, on the secondary screen, at least one app store options;
receiving, via the input device, one or more app store commands corresponding to one of the app store options; and
in response to receiving the one or more app store commands, downloading, via the Internet, a new application corresponding to the one of the app store options, from the database, and storing it in the memory.

14. The method of claim 13, wherein the new application downloaded from the database, when executed by the processor, produces output corresponding to the new application on the primary screen, wherein the output is separate and distinct from the first content previously displayed on the primary screen.

15. The method of claim 14, wherein the new application, when executed by the processor, outputs data to a widget program, which in turn configures data received from the new application and outputs it to the secondary screen.

16. The method of claim 13, wherein the new application downloaded from the database comprises a widget that displays information on the secondary screen while continuing to display the first content on the primary screen.

17. The method of claim 16, further comprising:
determining when to show the widget based on one or more of: limiting how often an application widget is launched, limiting how often an application widget is seen per day, and user preference for widgets from a particular application.

18. The method of claim 16, wherein the widget displays interactive content on the secondary screen while continuing to display the first content on the primary screen.

19. The method of claim 18, wherein the interactive content is related to the first content concurrently displayed on the primary screen.

20. The method of claim 19, wherein a selection of the interactive content causes the widget to launch, on the secondary screen, an application program found at a link accessible over the Internet while continuing to display the first content on the primary screen.

21. The method of claim 13, wherein the processor is a special purpose media processor, the method further comprising generating, using the processor, audio visual content for display on the primary screen.

22. The method of claim 21, wherein the television system further comprises a speaker, the method further comprising generating the audio visual content in a high-definition format synchronized with audio presented on the speaker.

23. The method of claim 13, wherein the secondary screen is integrated with the primary screen, wherein the secondary screen has a high-definition format, a size that is substantially a same width as the primary screen, and has a height that is between ⅓ and ¼ the height of the primary screen.

24. The method of claim 13, wherein the memory further comprises configuration information and/or user profile information, wherein executing the program instructions for the app store program further comprises displaying application name, application image, and/or additional details, to allow launch of the new application, using the input device.
